(19) United States
(12) Patent Application Publication
(10) Pub. No.: US 2026/0310505 A1
(43) Pub. Date: Oct. 8, 2026

(54) CONTEXTUAL BANDITS FOR REPLICA AUTOSCALING

(71) Applicant: International Business Machines Corporation, Armonk, NY (US)

(72) Inventors: Pavithra Harsha, Pleasantville, NY (US); Naoki Abe, Rye, NY (US); Chitra SUBRAMANIAN, Mahopac, NY (US); Shivaram Subramanian, Frisco, TX (US); Amadou Ba, Navan (IE)

(21) Appl. No.: 19/092,690

(22) Filed: Mar. 27, 2025

(51) Int. Cl. G06F 9/50

(52) U.S. Cl. CPC G06F 9/5027

(57) ABSTRACT

Contextual bandit for replica autoscaling is provided. This includes receiving a scaling request for the application, which comprises a set of component microservices operational on a computing system. Context information, including workload level information for multiple transactions of the application, is received based on the scaling request. Transaction-level predictors are applied to the context information, generating prediction values for a performance indicator associated with the application. A discrete constrained optimization formulation is solved based on these prediction values to generate a diverse solution pool of scaling actions. A scaling action is sampled from this pool, comprising a service replica count for at least one component microservice. Finally, a scaling recommendation is generated, including the respective service replica count for the at least one component microservice.

### BACKGROUND

The disclosure relates to discrete constrained optimization, and more particularly to, a data driven approach for resource scaling in the IT domain.

Contextual bandits are integral to numerous adaptive machine learning and online decision-making tasks. In a typical contextual bandit scenario, a learning or decision-making agent repeatedly encounters a context, selects an action based on past observations and the current context, and subsequently receives a reward. The primary objective of the learner is to maximize the long-term cumulative reward of the employed policy, achieving an optimal balance between exploration and exploitation.

Contextual bandit algorithms are pivotal in various fields, including e-commerce, where user experience is enhanced through personalized recommendations, and healthcare, where treatment plans are optimized. Contextual bandits have been effectively utilized in online personalization and recommendation systems, demonstrating versatility and practical value. Additionally, contextual bandits play a crucial role in IT auto scaling, such as managing server loads during peak times for e-commerce websites and streaming services, and in assortment pricing strategies for retail, ensuring a diverse range of product options to meet customer needs.

### SUMMARY

In various embodiments of the disclosure, a computer-implemented method for scaling microservices-based applications is described. The method includes retrieving, by a computer, a scaling request associated with a microservices-based application. The microservices-based application includes a set of component microservices operational on a computing system. The method further includes applying, by the computer, a plurality of transaction-level predictors on context information including workload level information for a plurality of transactions of the microservices-based application based on the scaling request. The method further includes generating, by the computer, a plurality of prediction values for a performance indicator associated with the microservices-based application based on the application of the plurality of transaction-level predictors. The method further includes solving, by the computer, a constrained optimization formulation based on the plurality of prediction values to generate a solution pool including a set of scaling actions. The method further includes sampling, by the computer, a scaling action from the set of scaling actions, the scaling action including a respective service replica count for at least one component microservice of the set of component microservices. The method further includes generating, by the computer, a scaling recommendation including the respective service replica count for the at least one component microservice of the set of component microservices.

Further aspects of the present disclosure are directed to systems and computer program products containing functionality consistent with the method described above.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures, wherein:

FIG. 1 is a diagram that illustrates a computing environment for constrained optimization for autoscaling applications, in accordance with an embodiment of the disclosure;

FIG. 2 is a diagram that illustrates an environment for constrained optimization for autoscaling applications, in accordance with an embodiment of the disclosure;

FIG. 3 is a sequence diagram that illustrates exemplary operations for generating scaling recommendations and training transaction-level predictors for an autoscaling application, in accordance with an embodiment of the disclosure;

FIG. 4 is a flowchart that illustrates a two-phase risk averse phased learning approach for solving a constrained optimization problem, in accordance with an embodiment of the disclosure; and

FIG. 5 is a diagram that illustrates a flowchart of an exemplary method for constrained optimization in autoscaling applications, in accordance with an embodiment of the disclosure.

### DETAILED DESCRIPTION

The IT resource allocation problem is the target application of the proposed system. In a microservices-based application, compute and memory resources are allocated to run instances of microservices in a distributed system, such as Kubernetes®. Allocation of such resources are often made to meet certain service level agreement such as latency targets. Since additional resource allocations come with added costs to the platform owners as well as the users, there is generally a great interest in optimizing the resource allocation to meet the requirements while minimizing the resource cost. Since metrics for the service performance, such as latency, depend on aspects of the environment such as the traffic, it is desirable to estimate them from operational data and use them in dynamical resource allocation and optimization while minimizing the cost of allocated resources. This need for dynamic allocation with online estimation or learning of the relevant aspects in presence of resource constraints is addressed by extending the contextual bandit approaches with constrained resource optimization.

Contextual bandits are central to many adaptive machine learning and online decision-making tasks, with applications spanning e-commerce to healthcare. In a contextual bandit setting, a learning or decision-making agent repeatedly receives a context, selects an action based on past observations and the current context, and receives a reward. The primary goal is to maximize the long-term cumulative reward of an employed policy, balancing exploration and exploitation. This balance ensures that the agent not only exploits known rewarding actions but also explores new actions that could potentially yield higher rewards in the future.

Conventionally, contextual bandits with a large action space have been tackled using various approaches. Some methods leverage specific function approximation techniques but do not support general-purpose models. More recent advancements addressing general-purpose models fall into three categories: methods assuming smoothness in the reward function, approaches relying on linearity in the action embedding space, and hierarchical disjoint-action categorization models. Due to the presence of constraints, non-smoothness, and the absence of a linear or hierarchical structure, these methods may not be directly applied to the current setting without additional problem-specific approximations.

All existing bandit algorithms focus on reward learning and ignore the underlying problem structure, which is well-known and established for many operations problems. Existing reward learning methods ignore this structure, requiring more complex models, black-box nature of the reward function, and a lot more data for trustworthy decision systems, making such methods hard to use in enterprise settings. Working with intermediate functions also helps in formulating constraints and understanding constraint violations. Constraint violations modeled as soft constraints in reward learning settings result in discontinuity in the reward function, making the learning hard and exposing the systems to considerable risk.

There are many applications where the number of actions (e.g., scale recommendations for service replicas in IT autoscaling) is very large and combinatorial in nature. An Inverse Gap Weighting (IGW)-based large action contextual bandit assumes a linear relationship between a context-dependent action embedding and context embedding that is learned and, in a user-specified class. However, in general, there are settings where such a relationship is at best only an approximate representation and/or may require complex and harder-to-learn models.

The proposed system addresses the design of a practical contextual bandit method for scenarios with a high-dimensional action space involving a structured discrete constrained optimization problem. The problem frequently arises in operations management domains, such as IT resource allocation. Rather than treating the entire action space as an opaque entity admitting a global reward regression function, the proposed system adopts a transparent white-box approach. This approach explicitly leverages the rich structure inherent in a reward optimization problem, enhancing both transparency and interpretability. Specifically, the proposed system formulates an overall reward function of a constrained optimization problem as a function of lower-level estimable functionals (also referred to as predictors), which capture the causal structure necessary to represent the action-reward relationship. These lower level functionals are effectively modeled using machine learning techniques, leveraging the problem structure that restricts causal dependencies to smaller dimensions. The proposed system predicts response variables of these lower-level models based on incoming contexts. This structured approach ensures that the constrained optimization formulation is more tractable compared to conventional decision-making approaches to solving constrained optimization problems with opaque reward-regression functions. Ignoring this structured approach would require a huge action space to be explicitly enumerated when the decisions are discrete, which is inefficient and time-consuming. The proposed system applies techniques such as Column Generation (CG) to develop a master-subproblem reformulation of the constrained optimization problem, which is tractably solvable by mixed-integer programming (MIP). This approach accommodates flexible, general-purpose predictors and leverages the inherent lower-dimensional problem structure for a more efficient representation of the large action space. The system integrates IGW action sampling with a diverse solution pool generation approach. The system generates a solution pool by solving a master-subproblem reformulation via CG using an optimization solver.

The proposed system applies a risk-averse phased learning approach to effectively address non-smoothness in the reward function due to optimization constraints. This approach highlights the dichotomy between extensive exploration early on in traditional bandits and more conservative (risk-averse) exploration under constraints until the boundaries are better understood, after which small violations are allowed for further understanding of the constraint landscape. By applying a phased learning approach, the system balances the need for exploration and exploitation while minimizing the risks associated with constraint violations.

In a microservices-based application, compute and memory resources are allocated to run instances of microservices in a distributed system, such as Kubernetes®. The number of replicas assigned to each microservice must be carefully managed to meet latency targets of user transactions while optimizing resource usage. Transaction latency is influenced only by the replicas of the specific services that the user transaction invokes, allowing latency constraints to be applied at a granular level based on known dependencies. The optimal replica configuration depends on varying load levels across different transaction types handled by the application, which represents the context. The approach ensures that latency deviation functions decrease with resources and increase with load, making the model interpretable and effective.

In a Kubernetes microservices environment, continuous learning is essential, as system conditions change and older profiling experiments—designed to capture performance metrics per transaction—may become outdated. This can occur due to the deployment of a new microservice version or resource contention from other applications sharing the same cluster. Additionally, for enterprise applications, minimizing profiling experiments while enabling real-time learning is critical.

The proposed system for autoscaling in a microservices-based application leverages advanced optimization techniques to dynamically recommend scaling actions based on varying workload levels. By receiving context information, including workload level data for multiple transaction types, the system applies a plurality of transaction-level predictors to forecast performance metrics such as transaction latency. This predictive capability allows the system to generate a solution pool of scaling actions, ensuring that service replicas are allocated efficiently to meet latency targets while minimizing resource consumption.

In various embodiments of the present disclosure, the technological field of IT autoscaling may be improved by configuring a system that enables a microservice-based application to adapt to changing workload patterns in real-time. By continuously monitoring and analyzing workload levels across user transactions, the system may proactively recommend the number of service replicas for at least one component microservice, ensuring optimal performance under varying conditions. This dynamic resource allocation helps maintain high availability and scalability for microservice-based applications with fluctuating user demand.

Additionally, the system employs a mixed integer programming (MIP) approach using Column Generation (CG) method to solve the constrained optimization formulation. This approach allows the system to explore a diverse set of solutions, providing flexibility in resource allocation and enabling the identification of near-optimal configurations. The use of Inverse Gap Weighing (IGW) for sampling scaling actions from the solution pool further enhances the system's ability to balance exploration and exploitation, ensuring efficient resource utilization.

Furthermore, the system's ability to train transaction-level predictors based on actual performance data (e.g., observed latency) ensures continuous improvement in the recommendation of scaling actions. By minimizing regression regret and adapting to changes in workload levels, the system maintains responsiveness and efficiency, consistently meeting latency targets and service level agreements (SLAs). This iterative learning process enhances the system's predictive accuracy, leading to more effective resource management over time for the microservices of the microservices-based application.

In various embodiments of the disclosure, a computer-implemented method for scaling microservices-based applications is described. The method includes retrieving, by a computer, a scaling request associated with a microservices-based application. The microservices-based application includes a set of component microservices operational on a computing system. The method further includes applying, by the computer, a plurality of transaction-level predictors on context information including workload level information for a plurality of transactions of the microservices-based application based on the scaling request. The method further includes generating, by the computer, a plurality of prediction values for a performance indicator associated with the microservices-based application based on the applying. The method further includes solving, by the computer, a constrained optimization formulation based on the plurality of prediction values to generate a solution pool including a set of scaling actions. The method further includes sampling, by the computer, a scaling action from the set of scaling actions, the scaling action including a respective service replica count for at least one component microservice of the set of component microservices. The method further includes generating, by the computer, a scaling recommendation including the respective service replica count for the at least one component microservice of the set of component microservices.

In various embodiments of the disclosure, each transaction of the plurality of transactions has a dependency on a subset of component microservices of the set of component microservices.

In various embodiments of the disclosure, each transaction-level predictor of the plurality of transaction-level predictors is a machine learning model that is conditioned on the context information and a partial scaling action representing service replicas of the subset of component microservices.

In various embodiments of the disclosure, the performance indicator is a transaction latency associated with a respective transaction of the plurality of transactions. Each prediction value of the plurality of prediction values is a transaction-level value of the transaction latency violation.

In various embodiments of the disclosure, the computer-implemented method further includes formulating the constrained optimization formulation with an objective function to minimize a total service replica cost across the set of component microservices while satisfying a constraint including a transaction latency violation (which is a performance indicator) associated with a respective transaction of the plurality of transactions.

In various embodiments of the disclosure, the computer-implemented method further includes that the solving of the constrained optimization formulation as a mixed integer programming (MIP) program is performed using a Column Generation (CG) method.

In various embodiments of the disclosure, the computer-implemented method further includes applying an Inverse Gap Weighing (IGW) method on the set of scaling actions to sample the scaling action from the set of scaling actions.

In various embodiments of the disclosure, the computer-implemented method includes solving the constrained optimization formulation as a mixed integer programming (MIP) program using a Column Generation (CG) method. This ensures the solution pool contains a diverse set of solutions, from which the IGW method samples the scaling action.

In various embodiments of the disclosure, the computer-implemented method includes applying a risk-averse learning approach using the Inverse Gap Weighing (IGW) method on the solution pool to sample the scaling action. This involves setting the scaling parameter (λ) and scaling exponent (ρ) to determine the hyperparameter (γ) in each epoch, following a schedule where λ decreases and ρ increases after each epoch.

In various embodiments of the disclosure, the computer-implemented method includes solving the constrained optimization formulation as a mixed integer programming (MIP) program using a two-phase Column Generation (CG) method. The first phase involves solving a hard version of the problem with a relaxed latency violation threshold in each round, while the second phase addresses a soft version of the problem.

In various embodiments of the disclosure, the computer-implemented method includes transitioning from the first phase to the second phase of solving the constrained optimization problem based on whether the target power-law exponent of a regression regret is above or below a defined threshold.

In various embodiments of the disclosure, the computer-implemented method further includes determining a transaction-level performance associated with the microservices-based application based on the scaling recommendation. The computer-implemented method further includes training the plurality of transaction-level predictors based on the transaction-level performance.

In various embodiments of the disclosure, the computer-implemented method further includes transmitting the scaling recommendation to a terminal device associated with the computing system.

In various embodiments of the disclosure, a computer-program product for optimizing service replicas of a microservices-based application is described. The computer-program product includes retrieving a scaling request associated with a microservices-based application. The microservices-based application includes a set of component microservices operational on a computing system. The computer-program product further includes applying a plurality of transaction-level predictors on context information including workload level information for a plurality of transactions of the microservices-based application based on the scaling request. The computer-program product further includes generating a plurality of prediction values for a performance indicator associated with the microservices-based application based on the applying. The computer-program product further includes solving a constrained optimization formulation based on the plurality of prediction values to generate a solution pool including a set of scaling actions. The computer-program product further includes sampling a scaling action from the set of scaling actions. The scaling action includes a respective service replica count for at least one component microservice of the set of component microservices. The computer-program product further includes generating a scaling recommendation including the respective service replica count for the at least one component microservice of the set of component microservices.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or various freely propagating electromagnetic waves, electromagnetic waves propagating through a waveguide, light pulses passing through a fiber optic cable, electrical signals communicated through a wire, and/or various transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

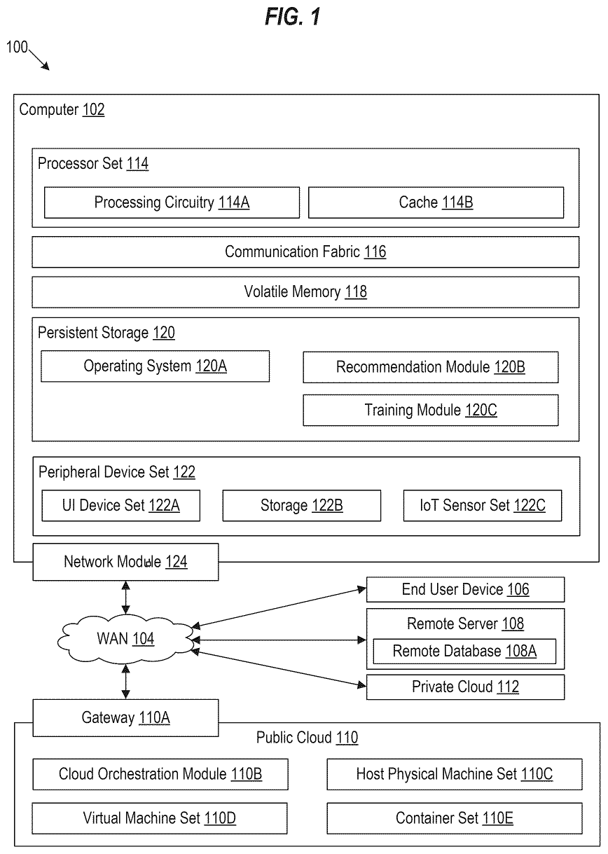

FIG. 1 is a diagram that illustrates a computing environment for constrained optimization for autoscaling and assortment pricing applications, in accordance with an embodiment of the disclosure. With reference to FIG. 1, there is shown a computing environment 100 that contains an example of an environment for the execution of at least some of the computer code involved in performing the disclosed methods, such as a recommendation module 120B and a training module 120C. In addition to the recommendation module 120B and the training module 120C, computing environment 100 includes, for example, a computer 102, a wide area network (WAN) 104, an End User Device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A, the recommendation module 120B, and the training module 120C, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or a wearable computer, a mainframe computer, a quantum computer, or any various forms of a computer or a mobile device now known or to be developed in the future that is capable of running a program, accessing a network or querying a database, such as the remote database 108A. As is well understood in the art of computer technology, and depending upon the technology, the performance of a computer-implemented method may be distributed among multiple computers and/or between multiple locations. In this presentation of the computing environment 100, detailed discussion is focused on a single computer, specifically the computer 102, to keep the presentation as simple as possible. The computer 102 may be located in a cloud, even though it is not shown in a cloud in FIG. 1. The computer 102 is not required to be in a cloud except to any extent as is affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the various storage media discussed below. The program instructions, and associated data, are accessed by the processor set 114 to control and direct the performance of the disclosed methods. In computing environment 100, at least some of the instructions for performing the disclosed methods may be stored in the dynamic modification of the recommendation module 120B and the training module 120C in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Various types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to computer 102, but alternatively or additionally, the volatile memory 118 may be distributed over multiple packages and/or located externally with respect to computer 102.

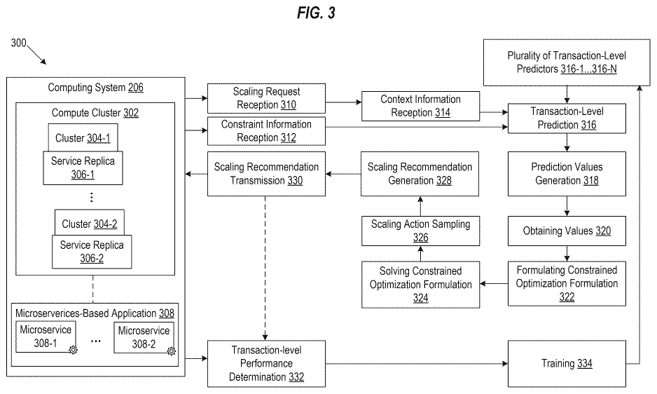

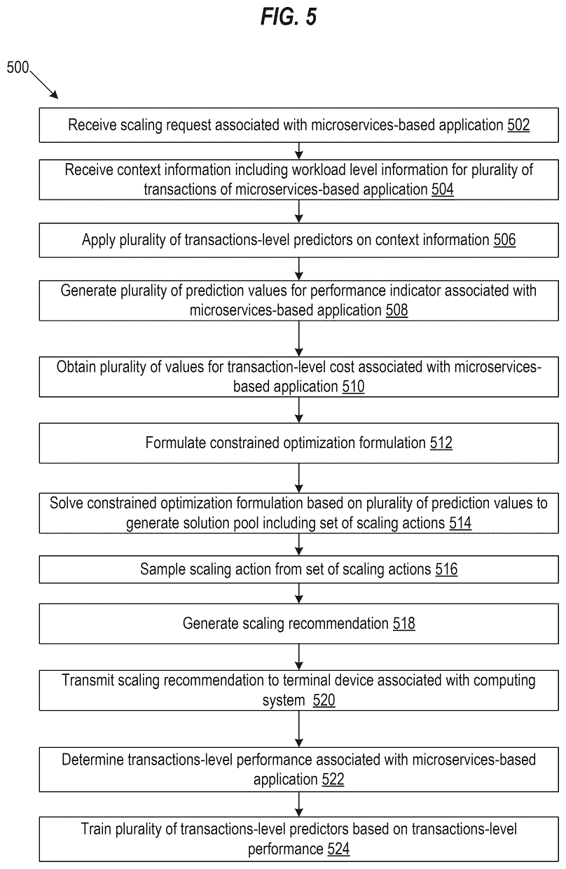

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 is a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the recommendation module 120B and the training module 120C typically includes at least some of the computer code involved in performing the disclosed methods. The recommendation module 120B may include suitable logic, circuitry, code, and/or interface for generating scaling recommendations for microservices of a microservice-based application. Details associated with the generation are provided, for example, in FIG. 3 and FIG. 5. The training module 120C may include suitable logic, circuitry, code, and/or interface training a plurality of transaction-level predictors (as shown in FIG. 3 and FIG. 5).

The peripheral device set 122 includes the set of peripheral devices of computer 102. Data communication connections between the peripheral devices and the various components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A includes components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows computer 102 to communicate with various computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

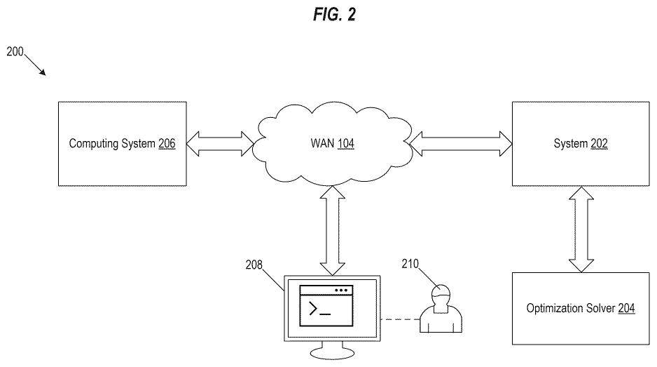

FIG. 2 is a diagram that illustrates an environment for constrained optimization for autoscaling and assortment pricing applications, in accordance with an embodiment of the disclosure. FIG. 2 is explained in conjunction with elements of FIG. 1. With reference to FIG. 1, there is shown a diagram of a network environment 200. The network environment 200 includes a system 202, an optimization solver 204, a computing system 206, and a terminal device 208. The terminal device 208 is associated with a user 210. The network environment 200 further includes the WAN 104 (as described in FIG. 1). In an embodiment of the disclosure, the terminal device 208 is an exemplary embodiment of the End User Device 106 of FIG. 1. Similarly, the system 202 is an exemplary embodiment of the computer 102 in FIG. 1.

The system 202 is a computer-based system that includes suitable logic, circuitry, and/or interfaces for generating action recommendations, such as scaling recommendations for a suitable application such as replica autoscaling in Information Technology (IT). In an embodiment, the system 202 manages the scaling of a microservices-based application (shown in FIG. 3). Specifically, the system 202 receives a scaling request and context information, including workload levels for a plurality of transactions of the microservices-based application. Further, the system 202 applies a plurality of transaction-level predictors (shown in FIG. 3) to this context information to generate prediction values for a performance indicator, such as a transaction latency violation. Based on these prediction values, the system 202 solves a constrained optimization problem to generate a solution pool of scaling actions. From this solution pool, the system 202 samples a scaling action, specifying service replica counts for at least one component microservice, and generates a scaling recommendation that includes these service replica counts. This ensures efficient and optimized scaling of microservices to handle varying workloads. As part of an online learning process, the system 202 trains the plurality of transaction-level predictors after generating the scaling recommendation.

Examples of the system 202 include, but are not limited to, a server, a computing device, a virtual computing device, a mainframe machine, a computer workstation, a smartphone, a cellular phone, a mobile phone, a gaming device, or a consumer electronic (CE) device. By way of example, and not limitation, the system 202 may be embodied as a cloud-based service, a cloud-based application, a cloud-based platform, a remote server-based service, a remote server-based application, a remote server-based platform, or a virtual computing system.

The optimization solver 204 is a computational tool that includes suitable logic, circuitry, code, and/or interfaces for generating a solution or a solution pool for a constrained optimization problem with a defined set of constraints. The optimization solver 204 may be a software-based mathematical programming tool, such as Gurobi® or CPLEX®. The optimization solver 204 may define an objective function, which represents the goal of the optimization (e.g., minimizing costs, maximizing profits), and a set of constraints that the solution must satisfy (e.g., resource limitations, regulatory requirements). Using advanced methods like linear programming, mixed-integer programming, and quadratic programming, the optimization solver 204 may handle large-scale problems with numerous variables and constraints. Additionally, the optimization solver 204 may use specialized computing resources, such as Quantum Computers or Graphical Processing Units (GPUs), to accelerate the solving process.

The computing system 206 is a versatile infrastructure for supporting various applications and services by efficiently managing and processing data. The computing system 206 includes hardware and software components such as compute clusters, storage systems, networking equipment, and specialized software for load balancing and data processing. In one embodiment, the computing system 206 manages a microservices-based application (shown in FIG. 3) with a compute cluster (shown in FIG. 3) for service replicas, a load balancer for traffic distribution, a service mesh for communication management, monitoring tools, and a container orchestration platform.

The terminal device 208 is a digital interface that allows interaction with the computing system 206 to initiate processes such as autoscaling or pricing rationalization. This terminal device 208 may be a computer, tablet, smartphone, or any other digital device equipped with the necessary software and connectivity. In the context of a microservices-based application, terminal device 208 may be an admin device used by system administrators to manage and initiate autoscaling processes. The terminal device 208 provides a user-friendly interface to monitor system performance, submit scaling requests, and receive scaling recommendations, featuring dashboards, control panels, notification systems, reporting tools, and the like.

FIG. 3 is a sequence diagram that illustrates exemplary operations for generating scaling recommendations and training transaction-level predictors for an autoscaling application, in accordance with an embodiment of the disclosure. FIG. 3 is explained in conjunction with elements from FIG. 1 and FIG. 2. With reference to FIG. 3, there is shown a sequence diagram 300 that includes operations from 310 to 334. In the sequence diagram 300, there is shown the computing system 206 that includes a compute cluster 302 having service replicas such as service replica 306-1 and service replica 306-2 operational within cluster 304-1 and cluster 304-2, respectively. As shown, the computing system 206 serves as a distributed system that provides the clusters such as cluster 304-1 and cluster 304-2 for running service replicas of a set of component microservices such as a microservice 308-1 and a microservice 308-2 of a microservice-based application 308.

As used herein, the term “compute cluster 302” may refer to a collection of interconnected computers that work together as a single system to ensure high availability, scalability, and performance. Each computer in the compute cluster 302 is called a node which shares resources to perform computations. For example, in a Kubernetes environment, the compute cluster 302 may include multiple nodes running containerized applications.

As used herein, the term “service replica” refers to an instance of a microservice in a distributed system, like Kubernetes®. For example, if a microservice is responsible for processing user requests, having multiple replicas ensures that the service remains available even if one instance fails.

As used herein, the term “microservice” refers to an independent service that performs a specific function within the microservice-based application 308. For example, an e-commerce application may have separate microservices for user authentication, product catalog, and order processing.

As used herein, the term “microservices-based application 308” refers to a software application that includes a set of component microservices operational on the computing system 206. Each component microservice is configured to execute a specific aspect of the application's functionality. For example, an online banking application may use microservices for account management, transaction processing, and fraud detection.

At 310, a scaling request associated with the microservices-based application 308 is received. The microservices-based application 308 includes a set of component microservices operational on the computing system 206. As an example, the system 202 receives the scaling request from the compute system 206 or via an input from the terminal device 208. The scaling request may require the number of service replicas assigned to at least one component microservice (e.g., scalable microservices) to be carefully managed to meet latency targets of user transactions while optimizing resource usage.

It should be noted that the system 202 may execute operations from 312 to 334 based on an epoch schedule after the receipt of the scaling request. The epoch schedule is defined by a sequence of time points, starting from τ₀, and ending at τ_{T}=T, with intermediate points τ₁, τ₂, and so on. For each epoch, the operations from 312 to 334 are iteratively executed through rounds within the specified time intervals. During each round, operations from 312 to 334 are executed, as described herein.

At 312, constraint information is received. The system 202 receives the constraint information such as a latency SLA (Service Level Agreement) associated with the microservices-based application 308. The latency SLA is a commitment between a service provider and a customer that specifies the maximum allowable time for a server (for example, the computing system) to receive, process, and respond to a request. The latency SLA sets a performance benchmark for how quickly a component microservice should respond to user requests. Such information is received from the compute system 206 or via an input from the terminal device 208.

At 314, context information including workload level information for a plurality of transactions of the microservices-based application 308 is received. In each round (τ ∈ [T]), the system 202 receives the context information based on the scaling request. Each transaction of the plurality of transactions corresponds has dependencies on subsets of component microservices within the set of component microservices. Notably, transaction latency is influenced only by the service replicas of the specific component microservices that are invoked, allowing latency constraints to be applied at a more granular level based on known dependencies. Additionally, an optimal replica configuration depends on varying workload levels across different transaction types handled by the microservices-based application 308. By way of example, and not limitation, the microservices-based application 308 may be a robot shop application that is deployed on a Kubernetes® cluster (an example implementation of the compute cluster 302) and includes five distinct component microservices and two downstream databases. Each transaction depends on specific services, with some services being scalable to handle varying workloads levels (e.g., requests in terms of API calls per second). An example of transactions and dependent component microservices is shown in Table 1, as follows:

TABLE 1
Transactions and Dependent component microservices

| Transaction Type | Dependent Services (Scalable ones in quotes) |
|---|---|
| User Transaction | web, “user”, redis |
| Catalogue | web, “catalogue”, mongoDB |
| Transaction | |
| Cart Transaction | web, “cart”, “catalogue”, mongoDB, redis |
| Shipping | web, “shipping”, “cart”, redis |
| Transaction | |

In Table 1, the web service handles incoming HTTP requests and routes such requests to the appropriate microservices, the user service manages user-related operations such as authentication and profile management. The catalogue service manages the product catalog, including product details and inventory and the cart service manages shopping cart operations, including adding and removing items. The shipping service manages shipping-related operations, including calculating shipping costs and tracking shipments. Similarly, the Redis database may be used for caching and session management MongoDB database is used for storing product and user data. Further, example transaction-level workload information, including the number of calls per second for the transactions is provided in Table 2, as follows:

TABLE 2
Example numbers for the call rates per second, which provide a picture
of the workload for each user transaction or transaction.

| | Transaction-Level Workload |
|---|---|
| Transaction Type | Information (context information) |
| User Transaction | Number of login requests per |
| | second (e.g., 50 calls/sec) |
| Catalogue Transaction | Number of product catalog requests |
| | per second (e.g., 100 calls/sec) |
| Cart Transaction | Number of add-to-cart operations |
| | per second (e.g., 30 calls/sec) |
| Shipping Transaction | Number of shipping confirmations |
| | per second (e.g., 20 calls/sec) |

At 316, a plurality of transaction-level predictors 316-1 . . . 316-N is applied on the context information. The system 202 applies the plurality of transaction-level predictors 316-1 . . . 316-N on this context information. Each transaction-level predictor is conditioned on both context information and partial scaling actions representing service replicas for subsets of component microservices. By way of example, and not limitation, each of the plurality of transaction-level predictors 316-1 . . . 316-N is a regression model such as an XGBoost latency model for a respective transaction type, where the replica counts of the dependent component microservices (e.g., represented by the partial scaling actions) and the workload level information across the N transaction types serve as features of the respective transaction-level predictor.

At 318, a plurality of prediction values for a performance indicator associated with the microservices-based application 308 is generated. The system 202 generates the plurality of prediction values by applying the plurality of transaction-level predictors 316-1 . . . 316-N on the context information. In addition to the context information, the system 202 may apply each of the plurality of transaction-level predictors 316-1 . . . 316-N on partial scaling action representing service replicas of component microservices associated with a respective transaction of the plurality of transactions. Specifically, for each transaction, a respective transaction-level predictor is applied to features that include the workload level information (from the context information) and the partial scaling action. The performance indicator is a constraint such as a transaction latency violation associated with a respective transaction and each of the plurality of prediction values reflects the transaction latency violation at a transaction level. For instance, a transaction-level predictor of transaction latency violation may be represented by Latency (cart transaction). The transaction-level predictor is applied to features such as a load vector (represents the workload information in terms of calls/sec) across all user transactions, and replicas of dependent microservices such as cart and catalogue (represents the partial scaling action).

At 320, a plurality of values for a transaction-level cost associated with the microservices-based application 308. The system 202 obtains the plurality of values based on a cost function of a scaling action corresponding to each of the plurality of transactions. It should be noted that a value of the cost function for a scaling action (such as service replicas of dependent microservices) is known. Therefore, the plurality of values may be combined with the per-microservice per-replica cost function. On the contrary, the plurality of transaction-level predictors 316-1 . . . 316-N for transaction latency violation is to be learned to satisfy monotonic properties with resource (service replicas) and load (context information).

At 322, a constrained optimization formulation is formulated. The system 202 formulates the constrained optimization formulation with an objective function to minimize a total service replica cost across the set of component microservices (such as microservice 308-1 and microservice 308-2) while satisfying constraints including the transaction latency associated with a respective transaction of the plurality of transactions. The objective function ensures that constraints like transaction latency violation per transaction are met effectively. The canonical constraint applies directly, and the objective function follows a standard resource consumption formulation, which is partitioned by user transactions, as the component microservices that such transactions invoke are known. As an example, the constrained optimization formulation is given by equation (1), which is as follows:

$${P}_{RO} ( x ) = {min}_{{a}_{j} ∈ A} {\sum }_{i ∈ J} {c}_{j} {a}_{j} , \qquad ( 1 )$$

such that Lᵢ(x, aᵢ)≤0 ∇i ∈ I
where,
J represents the set of component microservices, each with a user-defined replica range Aj and a per-replica cost cⱼ,
I denotes a set of user transactions, each with say a performance target βi,
Lᵢ denotes the first performance parameter referring to transaction latency violation w.r.t βi (depends only on the specific microservices that the transaction invokes),
aᵢ is a partial scaling action that represents service replicas, and
x denotes the workload level information across user transactions.
   Lᵢ(x, aᵢ) is an intermediate smaller dimensional functional, which is also referred to a transaction-level predictor. For example, the functional is a regression model that accepts the context information (x) and/or the partial scaling action (aᵢ) as features. Herein, aᵢ only spans a smaller dimension of the N dimensions such as tuples, triplets, or quadruplets.

Since each of the plurality of transaction-level predictors 316-1 . . . 316-N for the performance indicator (e.g., the latency violation constraint) is learned over time, the system 202 transforms the constrained optimization formulation of equation (1) into a soft penalized version, which is given by equations (2) and (3) for a user-defined input λⱼ for all i ∈ I, as follows:

$${P}^{λ} ( x ) = {min}_{{a}_{j} ∈ A} {\sum }_{i ∈ J} {Z}^{λ} ( x , a ) , \qquad ( 2 )$$

$$where$$

$${Z}^{λ} ( x , a ) = {\sum }_{i ∈ J} {c}_{i} ( x , {a}_{i} ) + {λ}_{i} {{L}_{i} ( x , {a}_{i} )}^{+} \qquad ( 3 )$$

In the context of autoscaling, the objective function Z^{λ}(x, a) is adapted to account for the dynamic allocation of resources (service replicas) to the set of component microservices based on varying workload levels. The cost function cᵢ(x, aᵢ) represents a resource consumption cost for each transaction (i), which includes the cost of compute and memory resources allocated to the service replicas. The latency function Lᵢ(x, aᵢ)⁺ (also referred to a transaction-level predictor) represents the transaction latency violation for each transaction (i), which depends on the number of service replicas allocated to the specific component microservices that the transaction invokes. It should be noted that+superscript refers to the positive part of L (Latency) in the equation (3). That is, \hat{L}+=max (L,0) (where L=latency−SLO). Thus, \hat{L}⁺=max(latency−SLO, 0), which is the amount of latency violation.

Equations (2) and (3) ensure that the total cost of service replicas is minimized while satisfying the latency constraints for user transactions. The soft penalized version allows for flexibility in meeting the constraints by incorporating a penalty term λᵢLᵢ(x, aᵢ)⁺ for any latency violations, enabling the compute system 206 to allocate resources efficiently to meet performance targets.

At 324, the constrained optimization formulation is solved to generate a solution pool which includes a set of scaling actions (also referred to as a diverse set of solutions). Each solution in the diverse set of solutions is an action vector that represents scaling actions in terms of service replica count for each of the set of component microservices. The system 202 solves the constrained optimization formulation based on the plurality of prediction values ( [symbol] (x, a₁), [symbol] (x, a₂), and so on) for the plurality of transactions (I) and/or the plurality of values (c₁(x, a₁), c₂(x, a₂), and so on) for the plurality of transactions (I).

In order to generate the solution pool, the system 202 executes the optimization solver 204 to solve the constrained optimization formulation using MIP constraints (e.g., target penalty vector: λ) and MIP pool parameters ((gap, size, capacity): g, s, l). The optimization solver 204 provides a solution pool feature, which when configured, generates multiple solutions beyond the optimal solution. A collection of such solutions is referred to as the solution pool. In an embodiment, the system 202 may configure the MIP pool parameters based on a user input to set a desired pool capacity. The solution pool enables exploration of alternative solutions, including those within a specified relative or absolute gap from optimality, using user-defined parameters. In an embodiment, the system 202 may receive a user input that specifies a pool replacement strategy when the solution pool reaches the capacity.

In accordance with an embodiment, the system 202 solves a hard variation or a soft variation of the constrained optimization formulation as a mixed integer programming (MIP) program using a Column Generation (CG) method. The hard variation requires the constraints to be strict constraints, and the soft variation requires a penalty to the latency constraint violation (the penalty is applied in the objective, as shown in equations (2) and (3)).

By way of example, and not limitation, the system 202 applies a decomposition technique of the CG method for the plurality of transaction-level predictors 316-1 . . . 316-N(e.g., lower-level functions such as Lᵢ(x, aᵢ)⁺) to solve a resultant discrete optimization problem to near-optimality. The system 202 decomposes the constrained optimization formulation of equations (2) and (3) into a high-dimensional restricted master program (RMP) and several low-dimensional subproblems (SP). This allows the constrained optimization formulation to converge to a tractable MIP model that is solvable directly using the optimization solver 204 such as CPLEX® and Gurobi® to generate a range of feasible solutions (e.g., referred to as the solution pool) instead of a single optimal solution.

In the CG method, any partial (low-dimensional) solution is represented as a sequence of scaling actions, which is referred to as a column. The key idea underlying the CG method is that in a practical optimization model, a vast majority of such columns are inefficient and are at zero in an optimal solution. The CG method relies on linear programming duality to explicitly consider only a restricted subset of high-quality candidate columns within the higher-dimensional RMPs. To achieve this restriction, the system 202 solves the low-dimensional SPs to implicitly filter out unrequired columns. The objective function of the RMP minimizes the total cost and constraints ensure that at most one column is unambiguously selected from the restricted columns provided by each subproblem (SP).

The CG method includes two phases. The first phase includes solving a hard version of the constrained optimization problem while relaxing a latency violation threshold in each round, and the second phase includes solving a soft version of the constrained optimization problem. Specifically, in the first ‘generate’ phase, the system 202 relaxes the discreteness restrictions in the RMP to construct a linear programming (LP) representation. For instance, the system 202 solves the relaxed RMP to obtain the optimal dual solutions associated with constraints and identifies no more than V columns per subproblem that satisfy the target constraints (for the hard version of the problem) having the lowest negative reduced cost. If there are no columns identified, the system 202 terminates the procedure and moves to the second phase. Otherwise, for each SP having the lowest negative reduced cost less than zero (0), the system 202 adds the columns to the RMP (as variables) and return to start of the first phase. In the second ‘select’ phase, the system 202 imposes discreteness on the RMP and solves the RMP as a MIP to generate the solution pool that includes a set of scaling actions. The procedure converges to an optimal LP solution when the reduced costs of all columns are non-negative. Since this LP at the end of the generate phase is a relaxation of the final (discrete) RMP, the value of the optimal objective function is a lower bound to the objective function of the constrained optimization formulation and acts as a quality guarantee. In an embodiment, the RMP may be solved by using a branch-and-price technique.

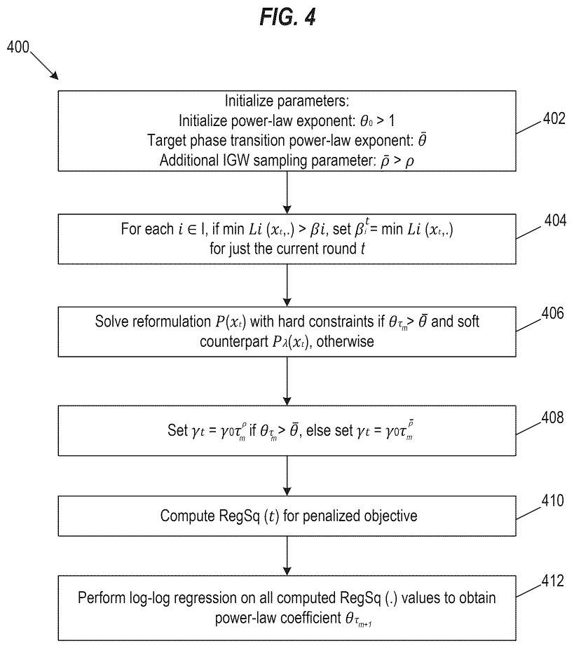

In accordance with an embodiment, the constrained optimization problem is solved such that a transition from the first phase to the second phase is performed based on a target power-law exponent (as shown in equation (5)) of a regression regret above or below a defined threshold. Further details related to the two-phase risk averse learning approach are provided in FIG. 4, for example.

For instance, the system 202 evaluates the value of the power-law exponent θₜ (specified in equation (5)) of the regression regret and sets the hyperparameter γₜ (in equation (5)) based on the value of the power-law exponent θₜ.

At 326, a scaling action is sampled from the set of scaling actions in the generated solution pool. The system 202 samples the scaling action from the set of scaling actions by applying an Inverse Gap Weighing (IGW) method on the set of scaling actions in the solution pool. The scaling action includes a respective service replica count for at least one component microservice of the set of component microservices.

IGW sampling for an NP-hard optimization problem such as the constrained optimization formulation of equation (1) is also NP-hard. Thus, the system 202 executes a heuristic method for IGW sampling with diversity by combining the vanilla IGW sampling method with the solution pool (obtained at 324). Specifically, the system 202 restricts the IGW sampling to the solution pool to balance the exploration-exploitation trade-off typically observed in large action spaces. For instance, consider the solution pool to be denoted by S. S* denotes a set of optimal solutions (or optimal scaling actions) in S, that is

$${S}^{*} = {argmin}_{a ∈ S} {Z}^{λ} ( a )$$

ana Z^{λ*} denotes a penalized objective of these solutions. The system 202 evaluates the penalized objective Z^{λ}(a) ∇a ∈ S and sets a value of γ hyperparameter, which is a time decaying value, based on equations (4) or equation (5), as follows:

$${γ}_{t} = {γ}_{0} {τ}_{m}^{ρ} \qquad ( 4 )$$

$${γ}_{t} = {γ}_{0} {τ}^{ρ ( 1 - {θ}_{t} ) +} \qquad ( 5 )$$

where γₜ, ρ are IGW sampling parameters (or hyperparameters),
θₜ is the power-law exponent, and
t represents the round index.

The system 202 further computes a sampling probability, pₜ based on the evaluated penalized objective, the set value of γ hyperparameter, and equations (6) and (7), which are given as follows:

$${p}_{t} ( a ) = \frac{1}{[ \vert S \vert + {γ}_{t} ( {Z}^{λ} ( a ) - {Z}^{λ *} ) ]} \qquad ( 6 )$$

$$∀ a ∈ S \backslash {S}^{*}$$

$${p}_{t} ( a ) = \frac{[ 1 - {\sum }_{a ∈ S \backslash {S}^{*}} {p}_{t} ( a ) ]}{\vert {S}^{*} \vert} \qquad ( 7 )$$

$$∀ a ∈ {S}^{*}$$

“a” represents the scaling action (a vector) in the solution pool, and
λ represents a target penalty vector.

The system 202 samples the scaling action from the solution pool based on the sampling probability (as shown in equations (6) and (7).

In accordance with an embodiment, the constrained optimization formulation is solved as the MIP program the CG method (as described at 324) such that the solution pool includes a diverse set of solutions (also referred to as diverse yet optimized set of solutions) as the set of scaling actions and the IGW method is applied on the solution pool to sample the scaling action from the set of scaling actions.

In accordance with an embodiment, the system 202 applies a risk-averse learning with the IGW method on the solution pool to sample the scaling action. The application includes setting a value of a scaling parameter, λ (also referred to as the target penalty vector in equation (7)) and a scaling exponent, ρ (also referred to as IGW sampling parameter in equations (4) and (5)) to set the hyperparameter, γ in each epoch, based on a schedule. Specifically, the risk-averse learning approach introduces a schedule for both λ and ρ based on the epochs. The setting performed by the system 202 is such that the value of the scaling parameter (λ) decreases, and the value of the scaling exponent (ρ) increases after each epoch. An alternative to the risk-averse learning approach is provided in FIG. 4, for example.

The exploration exploitation (Ex-Ex) principle dictates that we should explore more initially and gradually reduce exploration over time. The chosen setting of γₜ in equations (4) and (5) aligns precisely with this approach. When constraints are present, they tend to be associated with higher violation penalties in the objective Z^{λ}(x, a). Risk considerations favor a more cautious approach, discouraging excessive early exploration due to the cost discontinuities introduced by constraints. This effect is apparent when considering how IGW sampling would alter the distributions if the boundaries were known. Meeting the constraints requires learning functionals, and the objective of the present disclosure is to satisfy the constraints as much as possible. Early on, this may not be feasible, but as more information is gathered, the system 202 may better characterize them. While constraint violations are necessary for learning the boundary, larger violations are significantly more costly than smaller ones. This motivates a risk-averse learning method that prioritizes early exploration within the “known” boundary, and as the boundary becomes better characterized, exploration gradually shifts around its vicinity to better refine its understanding.

At 328, a scaling recommendation is generated. The system 202 generates the scaling recommendation that includes the respective service replica count for at least one component microservice of the set of component microservices. For example, for the robot shop application, the system 202 generates the scaling recommendation (e.g., in the form of an action vector) for the set of component microservices (e.g., scalable services) to ensure optimal performance and meet latency targets. For the user service the system 202 recommends scaling to 5 replicas. The catalogue service should be scaled to 8 replicas. The cart service is recommended to scale to 6 replicas. The shipping service should be scaled to 4 replicas. The scaling recommendation ensures that each scalable service handles the expected workload efficiently, maintaining performance and meeting latency targets.

At 330, the scaling recommendation is transmitted to the terminal device 208 associated with the computing system 206. The system 202 transmits the scaling recommendation to the terminal device 208. After the transmission, the computing system 206 executes the scaling recommendation by adding new service replicas for at least one component microservice (scalable services) of the set of component microservices based on respective service replica counts specified in the scaling recommendation.

At 332, a transaction-level performance associated with the microservices-based application 308 is determined. The system 202 determines the transaction-level performance based on the scaling recommendation. The transaction-level performance measures the impact of the scaling recommendation on the performance indicator(s) such as the transaction latency. For instance, following the execution of the scaling recommendation, the system 202 may measure improvements in terms of the transaction-level performance, particularly in terms of transaction latency. The user service, scaled to 5 replicas, now handles login requests with an average latency reduced to 150 ms, down from the previous 200 ms. similarly, the catalogue service, scaled to 8 replicas, processes product catalog requests with an average latency of 120 ms, compared to the earlier 150 ms. The cart service, scaled to 6 replicas, along with the catalogue service replicas at 8, now updates shopping carts with an average latency of 200 ms, a notable improvement from the previous 250 ms. The shipping service, scaled to 4 replicas, along with cart service at 6 replicas calculates shipping costs with an average latency of 250 ms, reduced from the prior 300 ms. The scaling recommendation helps to optimize resource allocation and improving transaction latency across the set of component microservices.

At 334, the plurality of transaction-level predictors 316-1 . . . 316-N is trained based on the transaction-level performance. The system 202 trains the plurality of transaction-level predictors 316-1 . . . 316-N based on the transaction-level performance. For instance, each of the plurality of transaction-level predictors 316-1 . . . 316-N is trained using offline least squares. The objective is to minimize the sum of squared errors between the first plurality of predicted values ( [symbol] ) and actual values (Lᵢ) for the performance indicator, e.g., the latency violation constraint. Specifically, for each transaction-level latency predictor, the objective function is expressed using equation (8), as follows:

$$min {\sum }_{i = 1}^{N} {( {L}_{i} - \text{?} )}^{2} \qquad ( 8 )$$

In online learning, the training of the plurality of transaction-level predictors 316-1 . . . 316-N occurs together with generation of the scaling recommendation at each time step. For instance, in each round, the system 202 trains the plurality of transaction-level predictors 316-1 . . . 316-N based on the transaction-level performance and generates the scaling recommendation for the computing system 206. This approach ensures that the microservices-based application 308 remains responsive and efficient under varying workload levels, adapting dynamically to changes in workload levels between subsequent time steps and ensuring that the number of replicas for at least one component microservice is adjusted proactively to meet latency targets/latency SLAs consistently. Also, the system 202 minimizes a regression regret for each of the plurality of transaction-level predictors 316-1 . . . 316-N during the training.

FIG. 4 is a flowchart that illustrates a two-phase risk averse phased learning approach for solving a constrained optimization problem, in accordance with an embodiment of the disclosure. FIG. 4 is explained in conjunction with elements from FIG. 1, FIG. 2, and FIG. 3. With reference to FIG. 4, there is shown a flowchart 400. The flowchart includes operations from 402 to 412, which may be executed by the system 202 of FIG. 2.

The operations in the flowchart 400 offer a simpler alternative, which is a two phased learning method for monotonic predictors using fewer parameters and leveraging the regression regret. We denote the latter as RegSq and use the cumulative square error of the penalized objective. The method includes two phases. The first phase includes solving a hard version of the constrained optimization problem while relaxing a latency violation threshold in each round, and the second phase includes solving a soft version of the constrained optimization problem. The phase transition is determined by a target power-law exponent describing the change in the observed RegSq(.) values (or a cumulative square error of the penalized objective as a proxy instead of regression regret).

At 402, parameters may be initialized. The system 202 may initialize the parameters such as a power law exponent (θ₀>1), a target phase transition power-law exponent (θ), and an additional IGW sampling parameter (ρ̅>ρ, also referred to as scaling exponent). Based on these parameters, the system 202 performs operations from 404 to 412.

At 404, the value of

$${β}_{i}^{t}$$

may be set after the generation of the plurality of prediction values at 316 of FIG. 3. For each transaction (i ∈ I), The system 202 sets the value

$${β}_{i}^{t} = {min L}_{i} ( {x}_{t} , . )$$

for the current round (t) if min Lᵢ(xₜ,.)>βᵢ.

At 406, reformulation P (xₜ) is solved at 324. The system 202 solves the reformulation with hard constraints if θτₘ>θ̅. Otherwise, the system 202 solves the reformulation with soft constraints (as depicted in equations (2) and (3).

At 408, the value of the hyperparameter (γt) is set (at 326). The system 202 may set the value of the hyperparameter

$${γ}_{t} = {γ}_{0} {τ}_{m}^{ρ}$$

if θτₘ>θ̅. Otherwise, the system 202 may set the value of the hyperparameter

$${γ}_{t} = {γ}_{0} {τ}_{m}^{\overline{ρ}} .$$

Alternatively, the system may set the value of the hyperparameter γₜ based on equation (5).

At 410, the value of Reg_{Sq}(t) for the penalized objective is computed (after 330). The system 202 may compute the value of Reg_{Sq}(t) (e.g., cumulative squared error) of the penalized objective.

At 412, a log-log regression on all computed values of Reg_{Sq}(·) is performed to obtain the power-law coefficient, θτₘ₊₁ (after 334). The system 202 may perform the log-log regression on all computed values of Reg_{Sq}(·) is performed to obtain the power-law coefficient, θτₘ₊₁.

FIG. 5 is a diagram that illustrates a flowchart of an exemplary method for constrained optimization in autoscaling applications, in accordance with an embodiment of the disclosure. FIG. 5 is explained in conjunction with elements from FIG. 1, FIG. 2, FIG. 3, and FIG. 4. With reference to FIG. 5, there is shown a flowchart 500. The operations of the exemplary method may be executed by any computing system, for example, by the computer 102 of FIG. 1 or the system 202 of FIG. 2. The operations of the flowchart 500 may start at 502.

At 502, a scaling request associated with the microservices-based application 308 is received. In an embodiment of the disclosure, the system 202 receives the scaling request associated with the microservices-based application 308. The microservices-based application 308 includes a set of component microservices (such as a microservice 308-1 and a microservice 308-2) operational on the computing system 206. Details about the reception of the scaling request are provided, for example, in FIG. 3.

At 504, context information including workload level information for a plurality of transactions of the microservices-based application 308 is received based on the scaling request. In an embodiment of the disclosure, the system 202 receives context information that includes workload level information for a plurality of transactions of the microservices-based application 308 based on the scaling request. Each transaction of the plurality of transactions has a dependency on a subset of component microservices of the set of component microservices. Details about the reception of the context information are provided, for example, in FIG. 3.

At 506, a plurality of transaction-level predictors 316-1 . . . 316-N is applied on the context information. In an embodiment of the disclosure, the system 202 applies a plurality of transaction-level predictors 316-1 . . . 316-N on the context information. Each transaction-level predictor of the plurality of transaction-level predictors 316-1 . . . 316-N is a machine learning model that is conditioned on the context information and a partial scaling action representing service replicas of the subset of component microservices. Details about the application of the transaction-level predictors are provided, for example, in FIG. 3.

At 508, a plurality of prediction values for a performance indicator associated with the microservices-based application 308 is generated based on the application of the plurality of transaction-level predictors 316-1 . . . 316-N. In an embodiment of the disclosure, the system 202 generates a plurality of prediction values for a performance indicator associated with the microservices-based application 308 based on the applying. The performance indicator is a transaction latency violation associated with a respective transaction of the plurality of transactions, and each prediction value of the plurality of prediction values is a transaction-level value of the transaction latency violation. Details about the generation of the plurality of prediction values are provided, for example, in FIG. 3.

At 510, a plurality of values for a transaction-level cost associated with the microservices-based application 308 is obtained. In an embodiment of the disclosure, the system 202 obtains a plurality of values for the transaction-level cost. Details about the obtaining of the plurality of values are provided, for example, in FIG. 3.

At 512, the constrained optimization formulation is formulated. In an embodiment of the disclosure, the system 202 formulates the constrained optimization formulation with an objective function to minimize a total service replica cost across the set of component microservices while satisfying a constraint including the transaction latency violation (which is the performance indicator) associated with a respective transaction of the plurality of transactions. Details about the formulation of the constrained optimization are provided, for example, in FIG. 3.

At 514, a constrained optimization formulation based on the plurality of prediction values is solved to generate a solution pool that includes a set of scaling actions. In an embodiment of the disclosure, the system 202 solves a constrained optimization formulation based on the plurality of prediction values to generate the solution pool. In an embodiment, the solving of the constrained optimization formulation is performed further based on the plurality of values. The solving a hard version or a soft version of the constrained optimization formulation as a mixed integer programming (MIP) program is performed using a Column Generation (CG) method. Details about the solving of the constrained optimization formulation are provided, for example, in FIG. 3.

At 516, a scaling action from the set of scaling actions is sampled. In an embodiment of the disclosure, the system 202 samples the scaling action from the set of scaling actions. The scaling action includes a respective service replica count for at least one component microservice of the set of component microservices. In an embodiment, the system 202 applies an Inverse Gap Weighing (IGW) method on the set of scaling actions to sample the scaling action from the set of scaling actions. Details about the sampling of the scaling action are provided, for example, in FIG. 3.

At 518, a scaling recommendation is generated. In an embodiment of the disclosure, the system 202 generates a scaling recommendation that includes the respective service replica count for at least one component microservice of the set of component microservices. Details about the generation of the scaling recommendation are provided, for example, in FIG. 3.

At 520, the scaling recommendation is transmitted to the terminal device 208 associated with the computing system 206. In an embodiment of the disclosure, the system 202 transmits the scaling recommendation to the terminal device 208 associated with the computing system 206. Details about the transmission of the scaling recommendation are provided, for example, in FIG. 3.

At 522, a transaction-level performance associated with the microservices-based application 308 is determined. In an embodiment of the disclosure, the system 202 determines the transaction-level performance associated with the microservices-based application 308 based on the scaling recommendation. Details about the determination of the transaction-level performance are provided, for example, in FIG. 3.

At 524, the plurality of transaction-level predictors 316-1 . . . 316-N is trained based on the transaction-level performance. In an embodiment of the disclosure, the system 202 trains the plurality of transaction-level predictors 316-1 . . . 316-N based on the transaction-level performance. Details about the training of the transaction-level predictors are provided, for example, in FIG. 3.

It should be noted that the operations from 504 to 524 are part of a single round within an epoch schedule that encompasses multiple epochs. These operations may be executed iteratively in an online learning manner, where the training of the plurality of transaction-level predictors 316-1 . . . 316-N is seamlessly integrated with the generation of the scaling recommendation in each round. This iterative execution ensures continuous improvement and adaptation of the plurality of transaction-level predictors 316-1 . . . 316-N, enhancing the overall efficiency and accuracy of the scaling recommendations.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable people of ordinary skill in the art to understand the embodiments disclosed herein.

What is claimed is:

1. A computer-implemented method, comprising:
receiving, by a computer, a scaling request associated with a microservices-based application,
the microservices-based application comprising a set of component microservices operational on a computing system;
receiving, by the computer, context information comprising workload level information for a plurality of transactions of the microservices-based application based on the scaling request;
applying, by the computer, a plurality of transaction-level predictors on the context information;
generating, by the computer, a plurality of prediction values for a performance indicator associated with the microservices-based application based on the applying;
solving, by the computer, a constrained optimization formulation based on the plurality of prediction values to generate a solution pool comprising a set of scaling actions;
sampling, by the computer, a scaling action from the set of scaling actions, the scaling action comprising a respective service replica count for at least one component microservice of the set of component microservices; and
generating, by the computer, a scaling recommendation comprising the respective service replica count for the at least one component microservice of the set of component microservices.

2. The computer-implemented method of claim 1, wherein each transaction of the plurality of transactions has a dependency on a subset of component microservices of the set of component microservices.

3. The computer-implemented method of claim 2, wherein each transaction-level predictor of the plurality of transaction-level predictors is a machine learning model that is conditioned on the context information and a partial scaling action representing service replicas of the subset of component microservices.

4. The computer-implemented method of claim 1, wherein
the performance indicator is a transaction latency violation associated with a respective transaction of the plurality of transactions, and
each prediction value of the plurality of prediction values is a transaction-level value of the transaction latency violation.

5. The computer-implemented method of claim 1, further comprising formulating, by the computer, the constrained optimization formulation with an objective function to minimize a total service replica cost across the set of component microservices while satisfying a constraint including a transaction latency associated with a respective transaction of the plurality of transactions.

6. The computer-implemented method of claim 1, wherein the solving of a hard variation or a soft variation of the constrained optimization formulation as a mixed integer programming (MIP) program is performed using a Column Generation (CG) method.

7. The computer-implemented method of claim 1, further comprising applying, by the computer, an Inverse Gap Weighing (IGW) method on the set of scaling actions to sample the scaling action from the set of scaling actions.

8. The computer-implemented method of claim 7, wherein the solving of the constrained optimization formulation as a mixed integer programming (MIP) program is performed using a Column Generation (CG) method such that the solution pool includes a diverse set of solutions as the set of scaling actions, and the IGW method is applied on the solution pool to sample the scaling action from the set of scaling actions.

9. The computer-implemented method of claim 1, further comprising applying, by the computer, a risk-averse learning with an Inverse Gap Weighing (IGW) method on the solution pool to sample the scaling action,
wherein the applying comprises setting, by the computer, a value of a scaling parameter (λ) and a scaling exponent (ρ) to set the hyperparameter (γ) in each epoch, based on a schedule, and
the setting is performed such that the value of the scaling parameter (λ) decreases, and the value of the scaling exponent (ρ) increases after each epoch.

10. The computer-implemented method of claim 1, wherein the solving of the constrained optimization formulation as a mixed integer programming (MIP) program is performed using a Column Generation (CG) method comprising of two phases, and
wherein the first phase comprises solving, by the computer, a hard version of the constrained optimization problem while relaxing a latency violation threshold in each round, and the second phase comprises solving a soft version of the constrained optimization problem.

11. The computer-implemented method of claim 10, further comprising transitioning, by the computer, the solving of the constrained optimization problem from the first phase to the second phase based on a target power-law exponent of a regression regret above or below a defined threshold.

12. The computer-implemented method of claim 1, further comprising:
determining, by the computer, a transaction-level performance associated with the microservices-based application based on the scaling recommendation; and
training, by the computer, the plurality of transaction-level predictors based on the transaction-level performance.

13. The computer-implemented method of claim 1, further comprising transmitting, by the computer, the scaling recommendation to a terminal device associated with the computing system.

14. A computer system, comprising:
a processor set;
one or more computer-readable storage media; and
program instructions stored on the one or more computer-readable storage media, the program instructions executable by the processor set to cause the processor set to:
receive a scaling request associated with a microservices-based application,
the microservices-based application comprising a set of component microservices operational on a computing system;
receive context information comprising workload level information for a plurality of transactions of the microservices-based application based on the scaling request;
apply a plurality of transaction-level predictors on the context information;
generate a plurality of prediction values for a performance indicator associated with the microservices-based application based on the applying;
solve a constrained optimization formulation based on the plurality of prediction values to generate a solution pool comprising a set of scaling actions;
sample a scaling action from the set of scaling actions, the scaling action comprising a respective service replica count for at least one component microservice of the set of component microservices; and
generate a scaling recommendation comprising the respective service replica count for the at least one component microservice of the set of component microservices.

15. The computer system of claim 14, wherein each transaction of the plurality of transactions has a dependency on a subset of component microservices of the set of component microservices, and
each transaction-level predictor of the plurality of transaction-level predictors is a machine learning model that is conditioned on the context information and a partial scaling action representing service replicas of the subset of component microservices.

16. The computer system of claim 14, wherein
the performance indicator is a transaction latency violation associated with a respective transaction of the plurality of transactions, and
each prediction value of the plurality of prediction values is a transaction-level value of the transaction latency violation.

17. The computer system of claim 14, wherein the program instructions further cause the processor set to formulate the constrained optimization formulation with an objective function to minimize a total service replica cost across the set of component microservices while satisfying a constraint including a transaction latency associated with a respective transaction of the plurality of transactions.

18. The computer system of claim 14, wherein the solving of the constrained optimization formulation as a mixed integer programming (MIP) program is performed using a Column Generation (CG) method.

19. The computer system of claim 14, wherein the program instructions further cause the processor set to apply an Inverse Gap Weighing (IGW) method on the set of scaling actions to sample the scaling action from the set of scaling actions.

20. The computer system of claim 14, wherein the program instructions further cause the processor set to:
determine a transaction-level performance associated with the microservices-based application based on the scaling recommendation; and
train the plurality of transaction-level predictors based on the transaction-level performance.

21. The computer system of claim 14, wherein the program instructions further cause the processor set to transmit the scaling recommendation to a terminal device associated with the computing system.

22. A computer-program product for optimizing service replicas of a microservices-based application, the computer-program product comprising:
one or more computer-readable storage media; and
program instructions stored on the one or more computer-readable storage media to perform operations comprising:
receiving a scaling request associated with a microservices-based application,
the microservices-based application comprising a set of component microservices operational on a computing system;
receiving context information comprising workload level information for a plurality of transactions of the microservices-based application based on the scaling request;
applying a plurality of transaction-level predictors on the context information;
generating a plurality of prediction values for a performance indicator associated with the microservices-based application based on the applying;
solving a constrained optimization formulation based on the plurality of prediction values to generate a solution pool comprising a set of scaling actions;
sampling a scaling action from the set of scaling actions, the scaling action comprising a respective service replica count for at least one component microservice of the set of component microservices; and
generating a scaling recommendation comprising the respective service replica count for the at least one component microservice of the set of component microservices.
